(19) United States
(12) Patent Application Publication
(10) Pub. No.: US 2004/0106724 A1
(43) Pub. Date: Jun. 3, 2004

(54) Natural rubber produced from latex and composition comprising the same

(76) Inventors: Hirotoshi Toratani, Kodaira-shi (JP); Seiichiro Iwafune, Kodaira-shi (JP); Ken Kijima, Kodaira-shi (JP); Hiromi Maeda, Kodaira-shi (JP); Takatsugu Hashimoto, Kodaira-shi (JP); Kazuhiro Yanagisawa, Kodaira-shi (JP)

Correspondence Address: SUGHRUE MION, PLLC, 2100 PENNSYLVANIA AVENUE, N.W., SUITE 800, WASHINGTON, DC, 20037, US

(21) Appl. No.: 10/362,415

(22) PCT Filed: Oct. 31, 2001
(86) PCT No.: PCT/JP01/09552

(30) Foreign Application Priority Data
Nov. 7, 2000 (JP) 2000-339233
Nov. 7, 2000 (JP) 2000-339234
Nov. 20, 2000 (JP) 2000-353124
Nov. 20, 2000 (JP) 2000-353125
Nov. 20, 2000 (JP) 2000-353126
Nov. 20, 2000 (JP) 2000-353127

(51) Int. Cl. C08K 3/04; C08K 3/22; C08K 5/01

(52) U.S. Cl. 524/575; 524/495; 524/492

(57) ABSTRACT

Provided is a natural rubber obtained by drying a gathered natural rubber latex without coagulating, wherein a drum dryer and/or a conveyor type dryer are used for drying. Further, provided are a production process for a natural rubber-filler mixture prepared by adding at least one of carbon black and inorganic fillers to a natural rubber latex, a natural rubber added a viscosity stabilizer comprising hydrazide compounds or esters of aromatic or aliphatic polycarboxylic acid derivatives to these natural rubber and natural rubber-filler mixture, and a rubber composition which is prepared using the above natural rubbers and which is excellent in productivity, abrasion resistance and fracture resistance:

### TECHNICAL FIELD

The present invention relates to a natural rubber into which a natural rubber serum comprising various useful non-rubber components that are not usually introduced into a natural rubber is introduced by drying a gathered natural rubber latex without coagulating, and which has a high molecular weight and is reduced in polymer gel, a composition comprising the same and a production process for a natural rubber-filler mixture prepared by adding carbon black and/or an inorganic filler such as silica, aluminas, and calcium carbonate to a natural rubber latex.

### BACKGROUND ART

In general, a natural rubber is produced in tropical countries such as Thailand, Malaysia and Indonesia. A natural rubber is widely used in a large quantity in the rubber industry and the tire industry because of excellent physical properties thereof.

A natural rubber is produced in steps of tapping—coagulation—cleaning (washing with water)—dehydrating—drying—packing and then classified according to production species and grades.

The following two processes have so far been typical as a production process for a natural rubber. That is, for a ribbed smoked sheets (RSS) graded according to the International Standards of Quality and Packing for Natural Rubber Grades (generally called Green Book), a natural rubber latex is treated with an acid after tapping to coagulate a rubber component, and then solid rubber is separated from the water soluble non-rubber component through rolls, and dried (smoking) at about 60° C. for 5 to 7 days.

For a technically specified rubber (TSR), a rubber component of a natural rubber latex is spontaneously coagulated after tapping (cup lump), and the solid rubber is dried at 110 to 140° C. for several hours by means of hot air after shredded, washed with water, and dehydrated.

In the respective processes described above, an alkali such as ammonia is added as a stabilizer to a gathered natural rubber latex in a certain case before coagulation.

In the respective processes described above, the natural rubber serum and the deposit remaining after obtaining the crude rubber (solid rubber) have so far been scarcely utilized. Contained in this natural rubber serum are components useful as well for a rubber component such as inositol, carbohydrates, proteins such as α-globulin, saccharides, ammonia sources, minerals, enzymes, nucleic acids and a vulcanization-accelerating component.

In natural rubbers obtained by the respective processes described above, however, time is taken at coagulating and drying steps, and involved in the steps is the problem that a change in the quality of non-rubber components caused by bacteria and hydrolysis from phospholipid to fatty acid are accelerated to deteriorate the physical properties of the natural rubbers.

Further, involved in a process for producing a natural rubber by the respective processes described above are the problems that a lot of foreign matters are mixed at the steps of coagulation—drying and that gelation which increases an amount of polymer gel that deteriorates the processability is accelerated under a drying condition in producing RSS, while there is a problem that the molecular weight is reduced under a drying condition in producing TSR, which result in exerting an adverse effect on the performances of the rubber.

Further, when a natural rubber is blended with aluminum hydroxide as an inorganic filler, particularly when aluminum hydroxide is used in combination with silica, the inorganic filler is reduced in dispersibility into the rubber, and the resulting vulcanized rubber composition is reduced in abrasion resistance when blended with a large amount of fillers of silica+aluminum hydroxide. This is because aluminum hydroxide is susceptible to reaction with an acid and an alkali, and it is difficult to prepare a stable master batch.

Also in the case of the other inorganic fillers such as a hydrated alumina, calcium carbonate, kaolin, clay, mica and feldspar, involved is the problem that an increase in the blending amount lowers the durability to reduce the abrasion resistance, the fracture resistance and the crack growth resistance, when vulcanized.

The present invention is intended to solve the conventional technical problems described above, and an object thereof is to provide a natural rubber into which a natural rubber serum comprising various useful non-rubber components that have not been introduced into the natural rubber is effectively introduced and which has a high molecular weight and is reduced in polymer gel, and to provide a rubber composition which does not have a significant change in physical properties after heat aging and is excellent in productivity and profitability while vulcanizing time can readily be shortened by using the natural rubber thus obtained that has such excellent characteristics.

Another object of the present invention is to provide a production process for a natural rubber-filler mixture which can inhibit an extreme rise in a vulcanizing speed and which prevents scorching during kneading and extruding, and can raise the productivity, when using the resulting natural rubber described above as a raw material.

Further, another object of the present invention is to provide a production process for a natural rubber-filler mixture which provides a vulcanized product of a rubber composition prepared by blending a rubber component comprising a natural rubber with a filler with durability, that is, excellent abrasion resistance, fracture resistance and crack growth resistance and which can raise the productivity of a non-vulcanized composition.

### DISCLOSURE OF THE INVENTION

Intensive researches repeated by the present inventors in order to solve the conventional technical problems described above have resulted in successfully obtaining a natural rubber meeting the objects described above by drying a natural rubber latex after tapping without coagulating to obtain a solid rubber or by drying a natural rubber latex added with a specific filler component before subjecting it to treatment such as drying, a composition comprising the same and a production process for a natural rubber-filler mixture. Thus, the present invention has come to be completed.

That is, the present invention comprises the following items 1 to 20.

1. A natural rubber obtained by drying a natural rubber latex by means of a drum dryer and/or a conveyor type dryer.

2. A natural rubber obtained by drying a natural rubber latex by means of a drum dryer and/or a conveyor type dryer without coagulation.

3. The natural rubber as described in above item 1 or 2, wherein the natural rubber latex described above is at least one of a fresh latex after tapping, a latex blended with a stabilizer and a centrifuged latex.

4. The natural rubber as described in any of above items 1 to 3, wherein the natural rubber latex described above has a solid concentration of 5% by weight or more.

5. The natural rubber as described in above item 4 containing a viscosity stabilizer.

6. The natural rubber as described in above item 5, wherein the viscosity stabilizer is a hydrazide compound represented by the following Formula (I):

R—CONHNH₂ (I)

wherein R represents an alkyl group having 1 to 30 carbon atoms, a cycloalkyl group having 3 to 30 carbon atoms or an aryl group.

7. The natural rubber as described in above item 5, wherein the viscosity stabilizer comprises at least one ester compound selected from the group consisting of aromatic polycarboxylic acid derivatives represented by the following Formula (II) and aliphatic polycarboxylic acid derivatives represented by the following Formula (III):

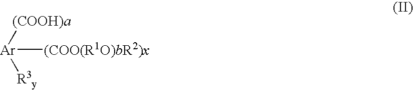

wherein b is an average degree of polymerization, and represents an integer of 1 or more; a and x each represent an integer of 1 or more; y represents an integer of 0 or more, and a relation of a+x+y=6 is satisfied; Ar is an aromatic hydrocarbon group; R¹ represents an alkylene group; R² represents any of an alkyl group, an alkenyl group, an alkylaryl group and an acyl group; R³ represents any of a hydrogen atom, an alkyl group and an alkenyl group.

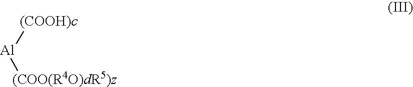

wherein d is an average degree of polymerization, and represents an integer of 1 or more; c and z each represent an integer of 1 or more; Al is a saturated or unsaturated aliphatic hydrocarbon group; R⁴ represents an alkylene group; R⁵ represents any of an alkyl group, an alkenyl group, an alkylaryl group and an acyl group.

8. The natural rubber as described in above item 5, wherein the viscosity stabilizer is an ester of a polycarboxylic acid with a (poly)oxyalkylene derivative, with at least one free carboxyl group bonded to the aromatic, or aliphatic hydrocarbon group.

9. The natural rubber as described in above item 6, wherein the hydrazide compound is at least one selected from the group consisting of acetohydrazide, propionohydrazide, butyrohydrazide, laurohydrazide, palmitohydrazide, stearohydrazide, cyclopropanecarbohydrazide, cyclohexanecarbohydrazide, cyclobutanecarbohydrazide, cycloheptanecarbohydrazide, o-toluohydrazide, m-toluohydrazide, p-toluohydrazide, benzohydrazide, lactohydrazide, phthalohydrazide, p-methoxybenzohydrazide, 3,5-dimethylbenzohydrazide and 1-naphthohydrazide.

10. A natural rubber-filler mixture comprising a natural rubber as described in any of above items 1 to 9 and a filler.

11. A natural rubber-filler mixture as described in above item 10, wherein the filler is at least one selected from the group consisting of carbon black, silica, aluminas represented by the following Formula (IV), calcium carbonate, talc, kaolin, clay, mica, and feldspar.

Al₂O₃ mH₂O (IV)

wherein m is an integer of 0 to 3.

12. The natural rubber-filler mixture as described in above item 10 or 11, wherein the filler described above has a content of 5 to 200% by weight based on a dry weight of the rubber component contained in the natural rubber latex.

13. A rubber composition obtained by compounding a rubber component as described in any of above items 1 to 9, and a filler.

14. A rubber composition obtained by compounding a rubber-filler mixture as described in any of above items 10 to 12.

15. A production process for a natural rubber characterized by drying a natural rubber latex by means of a drum dryer and/or a conveyor type dryer.

16. The production process for a natural rubber as described in above item 15, wherein a natural rubber latex is dried in the form of a sheet by means of the drum dryer, and the sheet-shaped natural rubber latex is further dried by means of the conveyor type dryer.

17. The production process for a natural rubber as described in above item 15 or 16, further comprising a step of adding a viscosity stabilizer.

18. A production process for a natural rubber-filler mixture comprising:

a step of adding at least one filler selected from the group consisting of carbon black, silica, aluminas represented by the following Formula (IV), calcium carbonate, talc, kaolin, clay, mica, and feldspar to a natural rubber latex; and

a step of drying the natural rubber latex-filler mixture.

Al₂O₃ mH₂O (IV)

wherein m is an integer of 0 to 3.

19. The production process for a natural rubber-filler mixture as described in above item 18, further comprising a step of adding a viscosity stabilizer.

20. The production process for a natural rubber-filler mixture as described in above item 18, wherein drying is carried out by means of a drum dryer and/or a conveyor type dryer.

### BEST MODE FOR CARRYING OUT THE INVENTION

The embodiment of the present invention shall be explained below in details.

The natural rubber of the present invention is characterized in that it is obtained by drying a natural rubber latex by means of a drum dryer and/or a conveyor type dryer.

Further, the production process for a natural rubber according to the present invention is characterized in that a natural rubber latex is dried by means of a drum dryer and/or a conveyor type dryer.

Also, the rubber composition of the present invention is characterized in that it comprises a rubber component and that the rubber component comprises a natural rubber obtained by drying the natural rubber latex described above (hereinafter referred to as “DD-NR”).

In the present invention, in a conventional production process for a natural rubber, that is, a process in which it is produced in steps of tapping—coagulation—cleaning (washing with water)—dehydrating—drying—packing, a natural rubber latex after tapping is subjected to drying treatment by means of a drum dryer and/or a conveyor type dryer without coagulating to thereby obtain the intended natural rubber.

The example of the natural rubber latex includes, for example, at least one (used alone or in combination of two or more kinds thereof) of a fresh latex after tapping which is used within about 3 hours since tapped from a natural rubber tree, a stabilized latex having preferably a pH of about 7.0 which is obtained by blending a natural rubber latex after tapping with a stabilizer such as ammonia, and a centrifuged latex obtained by centrifuging a latex after tapping by means of a centrifugal separator.

Contained in these natural rubber latices are components useful for a rubber component such as inositol, carbohydrates, proteins such as α-globulin, saccharides, ammonia sources, minerals, enzymes, nucleic acids and a vulcanization-accelerating component.

These natural rubber lattices preferably have a concentration of 5% by weight or more, more preferably 10% by weight or more and particularly preferably 15 to 70% by weight in terms of a solid concentration.

As the solid content of the natural rubber latices becomes lower, the useful components such as a vulcanization-accelerating component contained in the latices and the rubber content are reduced, and further the rubber itself comes to contain a lot of water, so that an additional step such as drying may be required at the subsequent step, which results in a reduction in the productivity. Thus, that is not preferred.

The drum dryer used in the present invention is, for example, a dryer equipped with a blade on a surface of a roll, a device for heating the inside of the roll such as a heater using steam or an electric heater and a device for dropping a latex continuously, and to be specific, it includes a two drum type drum dryer in which a natural rubber latex or a pre-heated natural rubber latex is continuously dried.

The conveyor type dryer includes, for example, a dryer equipped with a drying device such as heater, a far infrared ray device, a micro wave irradiation device and an air blower over an endless conveyor or over and under an endless conveyer so that the endless conveyor is superposed therebetween, in which a gathered natural rubber latex is spread in a thin layer on the conveyor and continuously dried.

A drying temperature in the drum dryer and the conveyor type dryer described above is suitably set up according to the species of a natural rubber latex used (produced), and it is preferably 80 to 200° C., more preferably 100 to 180° C. in both cases. The drying time is preferably 30 minutes or shorter, more preferably 10 minutes or shorter and particularly preferably one minute or shorter in the respective cases.

The latex can efficiently be dried by setting a drying temperature of the drum dryer and/or the conveyor type dryer described above at 100° C. or higher, and the temperature of 180° C. or lower makes it possible to obtain a natural rubber having good physical properties. Accordingly, the above temperature range is preferred.

The drying temperature of lower than 80° C. provides a rubber containing a lot of water and may require drying at a subsequent step, and therefore that is not preferred.

In the present invention, in drying a natural rubber latex by means of the drum dryer and/or the conveyor type dryer, a natural rubber latex is dried preferably in a sheet form in the ranges of the drying temperature and the time described above by a drum dryer, and then the above sheet-shaped natural rubber latex is further dried preferably in the ranges of the drying temperature and the time described above by a conveyor type dryer from a viewpoint of drying sufficiently the latex.

In the present invention, a viscosity stabilizer is preferably added to a gathered natural rubber latex before dried by the dryer described above.

Not only the useful components described above but also components such as amino acids which accelerate gelation are contained in a gathered natural rubber latex, so that a viscosity stabilizer is added to the gathered natural rubber latex, whereby the natural rubber latex is provided with an excellent viscosity stabilizing effect, and inhibition in gelation can be exhibited. To be specific, it is mixed therewith by means of a mixer or a kneader.

Further, the natural rubber latex containing no viscosity stabilizer or the natural rubber latex containing the viscosity stabilizer may be subjected to a strainer treatment. This provides a natural rubber latex which has a natural rubber having a high molecular weight and is free from dusts. The “strainer treatment” described above means a treatment in which a meshy member is used to remove dusts contained in the natural rubber latex which contains or does not contain a viscosity stabilizer.

The viscosity stabilizer shall be explained later.

The natural rubber of the present invention thus constituted is obtained by subjecting the natural rubber latex after tapping to drying treatment by means of the drum dryer and/or the conveyor type dryer without coagulating it, and therefore it is a natural rubber which is excellent in productivity because it is not subjected to coagulation, cleaning (washing with water) and dehydrating treatment, and which has a small foreign matter amount and can readily be controlled in the quality, and into which a natural rubber serum comprising various useful non-rubber components which have not been introduced are effectively introduced.

Further, the natural rubber latex after tapping is added the viscosity stabilizer described above and subjected to drying treatment by means of the drum dryer and the like, whereby capable of being obtained is the natural rubber which has a high molecular weight and is reduced in polymer gel and which has an excellent viscosity stabilizing effect.

Further, in the present invention, at least one filler selected from carbon black and inorganic fillers represented by silica, hydrated aluminas which can be represented by the following general Formula (IV), calcium carbonate, talc, kaolin, clay, mica, and feldspar can be added to the natural rubber latex described above before drying.

Al₂O₃ mH₂O (IV)

Wherein m is an integer of 0 to 3.

This filer may be used in combination with the viscosity stabilizer described above or the filler may be used alone without using the viscosity stabilizer described above.

Next, a method for obtaining the above natural rubber-filler mixture shall be explained.

This method which is one of the present inventions is characterized by comprising a step of adding at least one fille described above to a natural rubber latex to produce a natural rubber-filler mixed liquid and a step of drying the natural rubber-filler mixed liquid.

The present invention comprises a step of adding at least one filler selected from carbon black and inorganic fillers described above to the natural rubber latex before drying without coagulating it to produce a natural rubber-filler mixed liquid and a step of drying the natural rubber-filler mixed liquid, whereby the intended natural rubber-filler mixture is obtained.

The natural rubber latices described above can be used, and the latices have preferably a concentration of 10% by weight or more in terms of a solid concentration.

The example of the filler suitable for the present invention includes carbon black, and inorganic fillers such as silica, aluminas which can be represented by the above described general Formula (IV), calcium carbonate, talc, kaolin, clay, mica, feldspar, double salts, complex salts, and other minerals. Preferably, the filler is carbon black, silica, hydrated aluminas, calcium carbonate, talc, kaolin, clay, mica, and feldspar. And these fillers used preferably have an average particle diameter of 0.1 to 60 μm. These fillers can be used alone or in combination therewith.

Carbon blacks usually used in the rubber industry can be used as the carbon black and include, for example, SRF, FEF, GPF, HAF, ISAF and SAF.

Further, silicas usually used in the rubber industry can be used as silica and include, for example, wet process white carbon such as Nipsil AQ, Nipsil NA, Nipsil VE and Nipsil AR manufactured by Nippon Silica Ind. Co., Ltd. and dry process white carbon such as Aerosil 730 manufactured by Degusa AG.

Aluminum hydroxide includes, for example, Hygilite H-43M manufactured by Showa Denko K. K. and Apyral B manufactured by Bayer Ltd.

In a method for adding these fillers, the fillers may be added to the natural rubber latex as they are, and they are preferably mixed with water to be turned in advance into a slurry and then added from a viewpoint of improving dispersibility.

An addition amount of these fillers is preferably 5 to 200% by weight, more preferably 30 to 150% by weight based on the dry weight of the rubber component contained in the natural rubber latex.

If an addition amount of these filers is less than 5% by weight based on the dry weight of the rubber component contained in the natural rubber latex, an effect on improving the dispersibility is not sufficiently displayed in a certain case. On the other hand, if it exceeds 200% by weight, the rubber becomes hard, and the dispersibility of compounding ingredients are deteriorated in producing a rubber composition, so that such an amount is not preferred.

In the present invention, a mixer can be used at a step of adding at least one of the fillers described above to the natural rubber latex to produce a natural rubber-filler mixture.

Preferable mixing temperature at this step is 90 to 170° C., and mixing time is 1.5 to 15 minutes.

In the present invention, the above natural rubber-filler mixed liquid is dried after the step of producing it.

The drying means includes, for example, the drum dryer and/or the conveyor type dryer described above.

In drying the natural rubber-filler mixed liquid by the drum dryer and/or the conveyor type dryer, the natural rubber-filler mixed liquid is dried preferably in a sheet form in the ranges of drying temperature and time described below from a viewpoint of raising the productivity, and then the above sheet-shaped natural rubber-filler mixture is further dried preferably in the ranges of the drying temperature and time described below by the conveyor type dryer. The drying temperature and the drying time are suitably set up according to the species of a natural rubber latex used (produced).

As one example of the drying conditions, when the natural rubber-filler mixed liquid is first dried by the drum dryer and then by the conveyor type dryer, the drying temperature for the drum dryer is 95 to 160° C., preferably 105 to 150° C., and the drying time is 5 seconds to 1 minute, preferably 15 seconds to 30 seconds. The drying temperature for the conveyor type dryer is 95 to 170° C., preferably 105 to 160° C., and the drying time is 10 seconds to 2 minutes, preferably 15 seconds to 1 minute. In this case, the drying conditions for the conveyor type dryer should suitably be set up according to the state of the natural rubber-filler mixture after dried by the drum dryer.

In the present invention, a viscosity stabilizer may be added before the drying step described above, preferably at the step of adding the filter described above in producing the natural rubber-filler mixture.

According to this method, even if an inorganic filler described above other than carbon black, silica and aluminas are used as the filler, capable of being prevented is a reduction in the durability which is observed when an inorganic filler is blended by a conventional method with a natural rubber used as a raw material.

That is, obtained is a natural rubber-filler mixture in which the filler is raised in dispersibility to improve abrasion resistance and which is improved in durability such as abrasion resistance and crack growth resistance in comparison with one having the same blending amount of the filler and which is able to allow the other required performances, for example, a wetting performance and a gas permeability to be compatible with the durability. Further, it becomes possible to blend the filler in a large amount which has so far been difficult in conventional methods.

In the present invention, a liquid mixture obtained by adding a slurry of the filler to an natural rubber latex is dried by the drum dryer and the like, whereby the natural rubber-filler mixture (filler-NR master batch) can readily be obtained.

In particular, aluminum hydroxide reacts with an acid and an alkali because of an amphoteric salt and therefore is instable in a conventional latex coagulating method (acid coagulation), but use of the dryers described above makes it possible to inhibit the reaction to the utmost to obtain a stable master batch.

Next, the viscosity stabilizer used in the present invention shall be explained.

In the present invention, the viscosity stabilizer is added preferably at a step before dried by the dryer described above, more preferably to a gathered natural rubber latex.

The viscosity stabilizer used in the present invention includes, for example, semicarbazide, dimedone (1,1-dimethylcyclohexane-3,5-dione) and the hydrazide compound represented by the following Formula (I):

R—CONHNH₂ (I)

wherein R represents an alkyl group having 1 to 30 carbon atoms, a cycloalkyl group having 3 to 30 carbon atoms or an aryl group.

The hydrazide compound represented by Formula (I) described above includes, for example, acetohydrazide, propionohydrazide, butyrohydrazide, laurohydrazide, palmitohydrazide, stearohydrazide, cyclopropanecarbohydrazide, cyclobutanecarbohydrazide, cyclohexanecarbohydrazide, cycloheptanecarbohydrazide, benzohydrazide, o-dimethylbenzohydrazide, m-dimethylbenzohydrazide, o-toluohydrazide, m-toluohydrazide, p-toluohydrazide, p-methoxybenzohydrazide, 3,5-dimethylbenzohydrazide, lactohydrazide, phthalohydrazide and 1-naphthohydrazide.

A fatty acid hydrazide, particularly propionohydrazide is preferred as the viscosity stabilizer from a viewpoint of excellent dispersibility and further improvement in a viscosity stabilizing effect.

Another viscosity stabilizer which can be used in the present invention is an ester compound of a polycarboxylic acid with a (poly)oxyalkylene derivative, with at least one free carboxyl group left. This ester compound shall not specifically be restricted as long as it is obtained from a polycarboxylic acid and a (poly)oxyalkylene derivative.

One preferable type of esters is obtained by reaction between an aromatic polycarboxylic acid and (poly)oxyalkylene derivative, which has at least one free carboxyl group bonded to the aromatic ring in a molecule; this type of the ester compound can be represented by the following Formula (II):

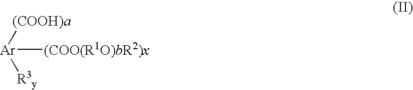

wherein b is an average degree of polymerization, and represents an integer of 1 or more; a and x each represent an integer of 1 or more; y represents an integer of 0 or more, and a relation of a+x+y=6 is satisfied; Ar is an aromatic hydrocarbon group; R¹ represents an alkylene group; R² represents any of an alkyl group, an alkenyl group, an alkylaryl group and an acyl group; R³ represents any of a hydrogen atom, an alkyl group and an alkenyl group.

In Formula (II) described above, more preferably, a+x is 2 or 3; R¹ is an alkylene group having 2 to 4 carbon atoms; and R is an alkyl group or alkenyl group having 2 to 28 carbon atoms. Further preferably, a=1 and x=1; R¹ is an ethylene group; and R² is an alkyl group or alkenyl group having 2 to 28 carbon atoms. Particularly preferably, b=1 to 10, a=1 and x=1; R¹ is an ethylene group; and R² is an alkyl group or alkenyl group having 8 to 18 carbon atoms. To be specific, mono(polyoxyalkylenelauryl) phthalate is included.

Another preferable type of esters is obtained by reaction between an aliphatic polycarboxylic acid and (poly)oxyalkylene derivative, which has at least one free carboxyl group bonded to the aliphatic hydrocarbon group in a molecule; this type of the ester compound can be represented by the following Formula (III):

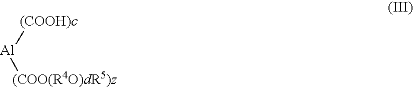

wherein d is an average degree of polymerization, and represents an integer of 1 or more; c and z each represent an integer of 1 or more; Al is a saturated or unsaturated aliphatic hydrocarbon group; R⁴ represents an alkylene group; R⁵ represents any of an alkyl group, an alkenyl group, an alkylaryl group and an acyl group.

In Formula (III) described above, more preferably, Al is an unsaturated aliphatic hydrocarbon group, and R⁴ is an alkylene group having 2 to 4 carbon atoms; and R⁵ is an alkyl group or alkenyl group having 2 to 28 carbon atoms. Further preferably, c=1 and z=1; R⁴ is an ethylene group or propylene group; and R⁵ is an alkyl group or alkenyl group having 8 to 18 carbon atoms. Particularly preferably, Al is an unsaturated aliphatic hydrocarbon group having 2 t 8 carbon atoms, d=1 to 10, c=1 and z=1; R⁴ is an ethylene group or propylene group; and R⁵ is an alkyl group or alkenyl group having 8 to 18 carbon atoms.

The esters represented by the formula (II), which can be used in the present invention can be obtained by reacting (i) an aromatic polycarboxylic acid having two or more carboxyl groups or an anhydride thereof with (ii) a (poly)oxyalkylene derivative.

The aromatic polycarboxylic acid of (i) includes, for example, aromatic dicarboxylic acids or anhydrides thereof such as phthalic acid, phthalic anhydride and naphthalenedicarboxylic acid; aromatic tricarboxylic acids or anhydrides thereof such as trimellitic acid and trimellitic anhydride; and aromatic tetracarboxylic acids or anhydrides thereof such as pyromellitic acid and pyromellitic anhydride. Di- or triaromatic carboxylic acids or anhydrides thereof are preferred from a viewpoint of the cost and their efficiency, and phthalic anhydride is particularly preferred.

These aromatic acids can be used alone or in combination of two or more.

The esters represented by the Formula (III), which can be used in the present invention can be obtained by reacting (iii) an aliphatic polycarboxylic acid having two or more carboxyl groups or an anhydride thereof with (ii) a (poly)oxyalkylene derivative.

The aliphatic polycarboxylic acid of (iii) includes, for example, saturated aliphatic dicarboxylic acids or anhydrides thereof such as succinic acid, succininc anhydride and glutaric acid, adipic acid; unsaturated aliphatic dicarboxylic acids or anhydrides thereof such as maleic acid and maleic anhydride, fumaric acid, itaconic acid, itaconic anhydride, citraconic acid, citraconic anhydride, alkenylsuccinic acid and alkenylsuccinic anhydride; and aliphatic tricarboxylic acids or anhydrides thereof such as tricarballylic acid and aconitic acid. Unsaturated aliaphatic dicarboxylic acids or anhydrides thereof are preferred from a viewpoint of the cost and their efficiency, and maleic anhydride is particularly preferred.

These aliphatic acids can be used alone or in combination of two or more.

The (poly)oxyalkylene derivative of (ii) described above is, for example, a derivative having a (poly)oxyalkylene group having at least one hydroxyl group and an average polymerization degree of 1 or more; preferably, it is the derivative having a (poly)oxyalkylene group having one to two hydroxyl groups; and particularly preferably, it is the derivative having a (poly)oxyalkylene group having one hydroxyl group. The (poly)oxyalkylene derivative includes, for example, an ether type such as (poly)oxyalkylene alkyl ether; an ester type such as (poly)oxyalkylene fatty acid monoester; an ether ester type such as (poly)oxyalkylene glycerin fatty acid ester; and nitrogen-containing type such as (poly)oxyalkylene fatty acid amide and (poly)oxyalkylene alkylamine. The ether type and the ester type are preferred as the (poly)oxyalkylene derivative of the present invention, and the ether type is particularly preferred.

The (poly)oxyalkylene derivative of the ether type includes, for example, saturated or unsaturated aliphatic ethers of polyoxyalkylenes such as polyoxyethylene lauryl ether, polyoxyethylene decyl ether, polyoxyethylene octyl ether, polyoxyethylene 2-ethylhexyl ether, polyoxyethylene polyoxypropylene lauryl ether, polyoxypropylene stearyl ether and polyoxyethylene oleyl ether; and polyoxyethylene aromatic ethers such as polyoxyethylene benzyl ether, polyoxyethylene alkylphenyl ether and polyoxyethylene benzylated phenyl ether. Among them, polyoxyalkylene aliphatic ethers are preferred.

Further, it is preferably polyoxyethylene alkyl or alkenyl ether, in particular, those in which polyoxyethylene has an average polymerization degree of 10 or less, and the alkyl group or the alkenyl group has preferably 8 to 18 carbon atoms.

To be specific, the examples thereof shall be shown below by abbreviating polyoxyethylene as POE (n) and showing an average polymerization degree in a parenthesis.

Included are POE (3) octyl ether, POE (4) 2-ethylhexyl ether, POE (3) decyl ether, POE (5) decyl ether, POE (3) lauryl ether, POE (8) lauryl ether and POE (1) stearyl ether.

The respective viscosity stabilizers described above used in the present invention can be added to the natural rubber latex as they are, but the viscosity stabilizers are preferably diluted with solvents to improve the dispersibility in a natural rubber latex, and suitable kinds of the solvents are set up according to the species of the viscosity stabilizers. Water (crude water, refined water, ion-exchanged water and purified water; hereinafter referred to merely as “water”) is preferably used as the solvent.

When the viscosity stabilizer described above is water-soluble, it can be used in the form of an aqueous solution, and when it is oil-soluble, it can be used in the form of an emulsion.

In the present invention, from a viewpoint of further excellent dispersibility and further improvement in the viscosity stabilizing effect, preferred is a viscosity stabilizer solution in which the viscosity stabilizer is the hydrazide compound represented by Formula (I) described above and the solvent is water.

In the present invention, the viscosity stabilizer emulsion can be obtained by a conventional method using an emulsifier and, if necessary, an affinity improving agent.

The aqueous solution has preferably a concentration of 20 to 80% by weight of the viscosity stabilizer, and the emulsion has preferably a concentration of 3 to 50% by weight of the viscosity stabilizer. When the concentrations described above are low (if the concentrations described above are less than 20% by weight or less than 3% by weight respectively), an amount of the viscosity stabilizer liquid (solution or emulsion) required for adding a desired amount of the viscosity stabilizer grows large. On the other hand, when the concentrations are high (if the concentrations described above exceed 80% by weight or 50% by weight respectively), caused in a certain case are the problems that stability of the liquid is damaged and the viscosity stabilizer is reduced in dispersibility. Accordingly, both cases are not preferred.

In the process of the present invention, various viscosity stabilizers described above can be used alone or in combination of two or more kinds thereof. The preferable blending amount thereof is 0.001 part by weight or more, more preferably 0.001 to 3 parts by weight, and particularly preferably 0.002 to 2 parts by weigh in terms of a dry weight based on 100 parts by weight of the natural rubber.

The blending amount of these viscosity stabilizers which is set at 0.001 part by weight or more makes it possible to display a better viscosity stabilizing effect and to obtain further effects which are the objects of the present invention without bringing about adverse effects such as deterioration in the rubber physical properties of resulting rubber composition.

Capable of being added, if necessary, to the natural rubber of the present invention obtained in the steps described above are optional components such as a reinforcing agent, a softening agent, a vulcanizing agent, a vulcanization accelerator, a accelerator activator and an antioxidant.

Next, the rubber composition using the natural rubber obtained above shall be explained.

In the rubber composition of the present invention, the DD-NR described above in details has preferably a content of 5% by weight or more, more preferably 10 to 100% by weight based on the total amount of the rubber component.

If the DD-NR described above has a content of less than 5% by weight, the effects of the present invention can not sufficiently be exhibited in a certain case.

In the present invention, other usable rubber components shall not specifically be restricted as long as they are conventionally used for a rubber composition. Preferably the additional rubber component is a diene based rubber, and the example includes rubber components such as natural rubber (NR), isoprene rubber (IR), butadiene rubber (BR), styrene butadiene rubber (SBR), butyl rubber (IIR), halogenated butyl rubber and ethylene propylene diene rubber (EPDM), each of which is obtained by conventional production processes.

Capable of being added, if necessary, to the rubber composition of the present invention are optional components such as a reinforcing agent, a softening agent, a vulcanizing agent, a vulcanization accelerator, a accelerator activator and an antioxidant.

The rubber composition of the present invention can be applied to a wide variety of rubber materials such as rubber for a tire including a tire tread and a conveyor belt.

The rubber composition of the present invention thus constituted comprises, as the rubber component, the natural rubber obtained by drying a natural rubber latex containing components which flow out from a natural rubber obtained by a conventional process, that is, useful components such as inositol, proteins such as α-globulin, saccharides, enzymes, nucleic acids and a vulcanization-accelerating component, and therefore the useful components such as a vulcanization-accelerating component can be left in the rubber component. This DD-NR contained therein makes it possible to accelerate vulcanization of the rubber composition and provides the rubber composition with the advantage that this acceleration of vulcanization does not bring about a change in the physical properties after heat aging unlike an increased amount of a conventional vulcanization accelerator. This provides the advantages that the vulcanization time can readily be shortened and an efficiency in the production can further be raised and that in addition thereto, blending of this DD-NR as a rubber component in a large amount makes it possible to decrease an amount of a vulcanization accelerator usually blended and thus makes it possible as well to reduce the blending cost.

### EXAMPLES

The present invention shall more specifically be explained below in details with reference to examples and comparative examples, but the present invention shall not be restricted to the examples described below.

The natural rubbers and the compositions obtained in the examples and the comparative examples were evaluated by the following methods.

I. Properties of a Natural Rubber

Evaluation Method of Molecular Weight:

The molecular weight was measured by gel permeation chromatography, wherein Gel Permeation Chromatograph HCL-8020 manufactured by Tosoh Corporation was used as a measuring instrument; GMHXL manufactured by Tosoh Corporation was used as a column; standard polystyrene manufactured by Tosoh Corporation was used for calibration; THF extra grade was used as a solvent; and 0.01 g sample/30 ml THF was used as a solution.

Evaluation Method of Foreign Matter Amount:

Measured based on ISO 249-1987.

Evaluation Method Of Fracture Resistance (Tensile Strength) (T_{B}):

A tensile strength (T_{B}) was measured based on JIS K 6251-1993 using a ring type No 5 specimen and shown by an index, wherein the value obtained in Comparative Example 1 was set at 100. The higher the value, the better the fracture resistance.

Evaluation Method of Modulus:

A tensile stress at 300% elongation was measured based on JIS K 6251-1993 and shown by an index, wherein the value obtained in Comparative Example 1 was set at 100. The higher the value, the higher the rigidity.

Evaluation Method of Foreign Matter Amount:

Measured based on ISO 249-1987.

Evaluation Method of Viscosity Stabilizing Effect:

Measured based on JIS K 6300-1994 were the Mooney viscosity: ML₁₊₄ (ORI) at 100° C. immediately after produced and the Mooney viscosity: ML₁₊₄ (AGED) at 100° C. after storing the natural rubber in an oven of 60° C. for 7 days, and a difference therebetween, [ML₁₊₄ (AGED)]−[ML₁₊₄ (ORI)], was determined as a viscosity stabilizing effect to evaluate the viscosity stabilizing effect.

II. Properties of a Rubber Composition

Evaluation Method of Fracture Resistance (Tensile Strength) (T_{B}) of a Vulcanized Rubber composition:

A tensile strength (T_{B}) was measured based on JIS K 6251-1993 using a dumbbell type No. 3 speciman and shown by an index, wherein the value obtained in Comparative Example 3 was set at 100. The higher the value, the better the fracture resistance.

Evaluation Method of Modulus of a Vulcanized Rubber Composition:

A tensile stress at 300% or 500% elongation was measured based on JIS K 6251-1993 and shown by an index, wherein the value obtained in Comparative Example 3 was set at 100. The higher the value, the higher the rigidity.

Evaluation Method of Vulcanization Speed of an Unvulcanized Rubber Composition:

Evaluated based on JIS K 6300-1994, wherein the value obtained in Comparative Example 3 or 4 was set as a control (set at 100 and shown by an index). The larger the index, the longer the time.

Evaluation Method of Tensile Strength, Modulus of a Vulcanized Rubber Composition:

Evaluated based on JIS K 6251-1993, wherein the value obtained in Comparative Example 3 was set as a control (set at 100 and shown by an index). The larger the index, the better the tensile strength (T_{B}).

Evaluation Method of Abrasion Test of a Vulcanized Rubber Composition:

Evaluated based on JIS K 6264-1993 (Lambourn test), wherein the value obtained in Comparative Example 3 or 4 was set as a control (set at 100 and shown by an index). The larger the index, the better the abrasion resistance.

Evaluation Method of Laboratory μ Index of a Vulcanized Rubber Composition:

The wet skid resistance was measured by using a British Portable Skid Tester manufactured by Stanley London at 15 degree C., and shown as an index wherein a value of a control is set at 100. The higher the index, the higher the μ.

Evaluation Method of Air Permeation Resistance of a Vulcanized Rubber Composition:

Measured by an A method (differential pressure method) of JIS K-7126-1995 and shown by an index, wherein the value obtained in Comparative Example 8 was set at 100 (control). The higher the index, the better the air permeation resistance.

Evaluation Method of Flex Cracking Growth of a Vulcanized Rubber Composition:

Evaluated based on JIS K-6260-1995 and shown by an index, wherein a flex cracking growth rate obtained in Comparative Example 8 was set at 100 (control). The higher the index, the faster the flex crack growth, and the worse the durability.

Evaluation Method of T0.9 (Vulcanization Speed) of an Unvulcanized Rubber Composition:

Curastometer manufactured by JSR Corporation was used to measure the vulcanizing speed at a temperature of 120±1° C. Measured was time required for obtaining 90% of the maximum value in a vulcanization torque curve.

Shown by an index, wherein the value obtained in Comparative Example 10 was set to a control (100). The lower the index, the faster the T0.9 (vulcanization speed) is.

Evaluation Method of Tensile Strength-Holding Rate Index (After Aging/Before Aging) After Heat Aging of a Vulcanized Rubber Composition:

Tensile strength-holding rate index was represented by (tensile strength after aging)/(tensile strength before aging) shown by an index, wherein the tensile strength before aging was represented by a tensile strength (T_{B}) determined by a No. 3 specimen of JIS K 6251-1993, and the tensile strength after aging was represented by a tensile strength of the No. 3 specimen after 24 hours at 100° C. in an air heat aging test of JIS K 6257-1993. The closer to 100 the index, the smaller the aging.

Evaluation Method of Blending Cost Index of an Unvulcanized Rubber Composition:

Calculated on the assumption that the cost (yen/kg) of conventional NR is the same as that of DD-NR of the present invention, wherein Comparative Example 10 was set to a control (100). The lower the index, the lower the blending cost, and the better the profitability.

III. Performance of a Tire

Evaluation Method of Abrasion Resistance Index:

An average abrasion resistance after running a tire having a size of 185/70 R¹³ having a tread made of a rubber composition of the present invention 20,000 km was shown by an index.

The raw material rubbers and the chemicals used in the following Examples and Comparative Examples are as follows:

NR: conventional RSS #3

RSS: A ribbed smoked sheet (RSS) in Comparative Example 1 was obtained by coagulating a rubber component contained in a natural rubber latex gathered after tapping with formic acid to separate the rubber component (solid rubber), washing the solid rubber with water, dehydrating and then drying (smoking) the solid rubber at about 60° C. for 5 days.

TSR: A technically specified rubber (TSR) in Comparative Example 2 was obtained by spontaneously coagulating a rubber component contained in a natural rubber latex obtained after tapping to separate the rubber component (solid rubber), washing the solid rubber with water, dehydrating and then hot air-drying the solid rubber at 120° C. for 3 hours.

DD-NR: Drum dried NR prepared in accordance with the method described in Examples

SBR:#1500 (trade mark manufactured by JSR Corporation)

Br-IIR: Bromobutyl 2244 (trade mark, manufactured by JSR Corporation)

Viscosity stabilizer *1: Laurohydrozide, added 10⁻³ mol per 100 parts by weight of dried NR latex

Viscosity stabilizer *2: Monostearylphthalate, added 10⁻³ mol per 100 parts by weight of dried NR latex

Viscosity stabilizer *3: Mono(polyoxyethylenelauryl)phthalate, added 10⁻³ mol per 100 parts by weight of died NR latex

viscosity stabilizer *4: propionohydrazide

viscosity stabilizer *5: lactohydrazide

viscosity stabilizer *6: laurohydrazide

GPF: general purpose furnace carbon black

SAF: (#90 trade mark, manufactured by Asahi Carbon Co. Ltd.; N110)

Aluminum hydroxide*1: Hygilite H-43M (trade mark, manufactured by Showa Denko K.K.

Aluminum hydroxide *2: Hygilite H-43M pulverized by a planet type ball mill having an average particle diameter of 0.4 μm

Silica: Nipsil VN3 (trade mark, manufactured by Nippon Silica Ind. Co. Ltd)

Clay: Polyfil 40 (trade mark, manufacture by JM Huber Corporation)

Si69: Silane coupling agent (trade mark, manufactured by Degussa AG; triethoxysilylpropyltetrasulfide)

TOP: tris-(1-ethylhexyl)phosphate

CZ: Noccelar CZ (trade mark manufactured by Ouchi Shinko Chem. Ind. Co. Ltd.; N-cyclohexyl-2-benzothiazolylsulfenamide.)

Noccelar DZ (trade mark manufactured by Ouchi Shinko Chem. Ind. Co. Ltd.; N,N′-dicyclohexyl-2-benzothiazolylsulfenamide

CBS (Noccelar CBS (trade mark manufactured by Ouchi Shinko Chemical Industrial Co. Ltd.; N-cyclohexyl-2-benzothiazorylsulfenamide

TOT: (Noccelar TOT-N (trade mark manufactured by Ouchi Shinko Chemical Industrial Co. Ltd.; tetrakis-2-ethylhexylthiuram disulfide

6C: Nocrac 6C (trade mark manufactured by Ouchi Shinko Chem. Ind. Co. Ltd.; N-(1,3-dimethylbutyl)-N′-p-phenylenediamine

### Examples 1 to 4 and Comparative Examples 1 to 2

A natural rubber latex obtained after tapping was subjected to treatments shown bellow and in the following Table 1 to obtain natural rubbers.

In Example 1, a natural rubber latex obtained after tapping was used and dried at 130° C. for 30 seconds by means of a two drum type drum dryer to obtain a natural rubber (DD-NR*¹).

In Examples 2 to 4, the respective viscosity stabilizers were added to natural rubber latices gathered after tapping in addition amounts shown in the following Table 1, and the latices were dried under the same conditions as in Example 1 described above by the drum dryer to obtain natural rubbers.

### Examples 5 to 8

In Example 5, a natural rubber latex gathered after tapping was used and dried at 130° C. for one minute by means of a conveyor type dryer to obtain a natural rubber (DD-NR*²).

In Examples 6 to 8, the respective viscosity stabilizers were added to natural rubber latices gathered after tapping in addition amounts shown in the following Table 1, and the latices were dried under the same conditions as in Example 5 described above by the conveyor type dryer to obtain natural rubbers.

### Examples 9 to 12

In Example 9, a natural rubber latex gathered after tapping was used and dried at 120° C. for 30 seconds by means of the drum dryer while making a sheet form, and then the sheet was further dried at 120° C. for one minute by the drum dryer to obtain a natural rubber (DD-NR*³).

In Examples 9 to 12, the respective viscosity stabilizers were added to natural rubber latices gathered after tapping in addition amounts shown in the following Table 1, and the latices were dried under the same conditions as in Example 9 described above to obtain natural rubbers.

The respective natural rubbers thus obtained were evaluated for a molecular weight, a foreign matter amount, a fracture resistance (TB), a modulus and a viscosity stabilizing effect by the methods described above.

The results thereof are shown in the following Table 1.

TABLE 1

| | Comparative | | | | | |
|---|---|---|---|---|---|---|
| | Example | | Example | | | |
| | 1 | 2 | 1 | 2 | 3 | 4 |
| Production process | RSS | TSR | DD-NR ^{*1} | DD-NR ^{*1} + | DD-NR ^{*1} + | DD-NR ^{*1} + |
| | | | | viscosity | viscosity | viscosity |
| | | | | stabilizer ^{*1} | stabilizer ^{*2} | stabilizer ^{*3} |
| Drying time | 5 days | 3 hours | 30 seconds | 30 seconds | 30 seconds | 30 seconds |
| Molecular weight | 182 | 150 | 190 | 192 | 191 | 189 |
| Foreign matter amount | 0.04 | 0.06 | 0.02 | 0.02 | 0.02 | 0.02 |
| Fracture resistance (T_{B}) | 100 | 91 | 101 | 105 | 102 | 103 |
| Modulus | 100 | 88 | 130 | 133 | 130 | 132 |
| Viscosity stabilizing effect | 11.5 | 10.3 | 12.0 | 2.1 | 3.2 | 2.8 |

| | Example | | | |
|---|---|---|---|---|
| | 5 | 6 | 7 | 8 |
| Production process | DD-NR ^{*2} | DD-NR ^{*2} + | DD-NR ^{*2} + | DD-NR ^{*2} + |
| | Conveyor | viscosity | viscosity | viscosity |
| | drying | stabilizer ^{*1} | stabilizer ^{*2} | stabilizer ^{*3} |
| Drying time | One minute | One minute | One minute | One minute |
| Molecular weight | 188 | 189 | 183 | 188 |
| Foreign matter amount | 0.02 | 0.02 | 0.02 | 0.02 |
| Fracture resistance (T_{B}) | 102 | 104 | 102 | 103 |
| Modulus | 127 | 131 | 127 | 129 |
| Viscosity stabilizing effect | 11.0 | 1.8 | 2.9 | 2.3 |
| | Example | | | |
| | 9 | 10 | 11 | 12 |
| Production process | Drum + | DD-NR ^{*3} + | DD-NR ^{*3} + | DD-NR ^{*3} + |
| | conveyor drying | viscosity | viscosity | viscosity |
| | DD-NR^{*3} | stabilizer ^{*1} | stabilizer ^{*2} | stabilizer ^{*3} |
| Drying time | 1.5 minute | 1.5 minute | 1.5 minute | 1.5 minute |
| Molecular weight | 192 | 195 | 193 | 195 |
| Foreign matter amount | 0.02 | 0.02 | 0.02 | 0.02 |
| Fracture resistance (T_{B}) | 103 | 106 | 104 | 106 |
| Modulus | 130 | 132 | 130 | 132 |
| Viscosity stabilizing effect | 12.1 | 2.0 | 2.9 | 2.6 |

As apparent from the results shown in Table 1 described above, it has been found that the natural rubbers obtained in Examples 1 to 12, which fall in the scope of the present invention have a large molecular weight and are low in a foreign matter amount and excellent in a fracture resistance (TB), a modulus and that the natural rubber containing the viscosity stabilizer are excellent in a viscosity stabilizing effect, as compared with those obtained in Comparative Examples 1 to 2, which fall outside the scope of the present invention.

Evaluation of a Mooney Viscosity of the Respective Rubbers (Raw Material Rubbers) After Left Standing for 3 Months.

Measured were Mooney viscosities of the respective rubbers used in the following Examples 13 to 17 and Comparative Examples 3 to 5 immediately after produced, and measured as well were the Mooney viscosities after left standing for 3 months at a temperature of 25° C. and a humidity of 40%. A change in the Mooney viscosities was shown by an index (setting the Mooney viscosity immediately after produced of respective rubber at 100) and evaluated. The results thereof are shown in the following Table 2.

TABLE 2

| Respective rubbers used in examples | Mooney viscosity change index |
|---|---|
| and comparative examples | after left standing for 3 months |
| (1) NR | 138 |
| (2) CB-NR master batch 1 | 140 |
| (3) CB-NR master batch 2 | 138 |
| (4) CB-NR master batch 2 + | 104 |
| propionohydrazide (0.3 phr) | |
| (5) Silica-NR master batch | 142 |
| (6) Silica-NR master batch + | 106 |
| lactohydrazide (0.6 phr) | |

As apparent from the results shown in Table 2 described above, that is, the results of stability of the raw materials, that is, the rubbers or the rubber-filler master batches to standing, it has been found that the compositions in which a Mooney viscosity has a small change and which are stable with the passage of time is obtained in a system using the viscosity stabilizer, so that a fluctuation and a dispersion in the rubber physical properties are inhibited in a rubber processing step and the workability can be improved.

### Examples 13 to 15 and Comparative Example 3

Tread rubber compositions of tires for a truck were prepared according to blending formulations containing a natural rubber and the like shown in the following Table 3. The blending unit is part by weight.

Conventional RSS #3 was used as the natural rubber used in Comparative

### Example 3

Used in Example 13 was a natural rubber obtained by mixing a natural rubber latex (a product having a solid concentration: DRC (dried rubber content) of 30%) which was not subjected to coagulation treatment with the same weight of a 15% carbon black (SAF) aqueous slurry by means of a mixer (mixing temperature: 25° C., mixing time: 1 minute) and then subjecting it to drying treatment (drying condition: 130° C., drying time: 20 seconds) by means of a drum dryer.

In Example 14, used in combination with the natural rubber prepared in Comparative Example 3 in the amounts described in the following Table 3 was a natural rubber obtained by mixing a natural rubber latex (a product having a DRC of 30%) which was not subjected to coagulation treatment with the same weight of a 30% carbon black (SAF) aqueous slurry by means of a mixer (mixing temperature: 25° C., mixing time: 1 minute) and then subjecting it to drying treatment (drying condition: 130° C., drying time: 20 seconds) by means of the drum dryer.

Used in Example 15 was a natural rubber obtained by adding propionohydrazide aqueous solution in an amount corresponding to a ratio of 0.3 phr based on the natural rubber at the time of mixing the aqueous slurry used in Example 14 and then treating it in the same manner as in Example 14.

The respective rubber compositions thus obtained were evaluated for a vulcanization speed, a tensile strength, modulus and abrasion test by the methods described above and shown by indices.

The results thereof are shown in the following Table 3.

TABLE 3
(Tread rubber composition for a truck tire)

| | |
|---|---|
| Comparative | |
| Example | Example |

| | 3 | 13 | 14 | 15 |
|---|---|---|---|---|
| NR | 100 | — | 50 | 50 |
| CB-NR master batch 1 | — | 150 | | |
| CB-NR master batch 2 | — | — | 100 | 100 |
| viscosity stabilizer*⁴ | — | — | — | 0.3 |
| SAF | 50 | — | — | — |
| Aromatic oil | 3 | 3 | 3 | 3 |
| Resin | 1 | 1 | 1 | 1 |
| Stearic acid | 2 | 2 | 2 | 2 |
| 6C | 1 | 1 | 1 | 1 |
| Zinc white | 3 | 3 | 3 | 3 |
| CBS | 0.8 | 0.8 | 0.8 | 0.8 |
| Sulfur | 1 | 1 | 1 | 1 |
| Vulcanization speed | 100 | 82 | 90 | 90 |
| Tensile strength | 100 | 106 | 108 | 108 |
| 300% modulus | 100 | 102 | 103 | 103 |
| 500% modulus | 100 | 107 | 110 | 110 |
| Abrasion test | 100 | 108 | 110 | 109 |

CB-NR master batch 1: the same weight of a 15% SAF aqueous slurry was mixed with a DRC 30% product of NR latex, and the mixture was subjected to drum drying. CB-NR master batch 2: the same weight of a 30% SAF aqueous slurry was mixed with a DRC 30% product of NR latex, and the mixture was subjected to drum drying.

### Examples 16 and 17 and Comparative Examples 4 and 5

Tire tread rubber compositions were prepared according to blending formulations containing a natural rubber and the like shown in the following Table 4. The blending unit is part by weight.

Conventional RSS #3 was used as the natural rubber used in Comparative Examples 4 and 5 (silica was added in preparing the rubber compositions).

In Example 16, used was a natural rubber obtained by mixing a natural rubber latex (a product having a DRC of 30%) which was not subjected to coagulation treatment with the same weight of a 30% silica aqueous slurry by means of a mixer (mixing temperature: 25° C., mixing time: 1 minute) and then subjecting it to drying treatment (drying condition: 130° C., drying time: 20 seconds) by means of the drum dryer.

Used in Example 17 was a natural rubber obtained by adding lactohydrazide, in a form of an emulsion, in an amount corresponding to a ratio of 0.6 phr based on the natural rubber at the time of mixing the aqueous slurry used in Example 16 and then treating it in the same manner as in Example 16.

The respective rubber compositions thus obtained were evaluated for a vulcanizaion speed, and a abrasion test by the methods described above and shown by indices. Further, the laboratory μ index was evaluated by the method described above, wherein the value obtained in Comparative Example 4 was set as a control at 100 and shown by an index.

TABLE 4
(Tread rubber composition for a passenger tire)

| | |
|---|---|
| Comparative | |
| Example | Example |

| | 4 | 5 | 16 | 17 |
|---|---|---|---|---|
| NR | 70 | 70 | 35 | 35 |
| Silica-NR master batch | — | — | 70 | 70 |
| viscosity stabilizer*⁵ | — | — | — | 0.6 |
| BR | 30 | 30 | 30 | 30 |
| SAF | 50 | 15 | 15 | 15 |
| Silica | — | 35 | — | — |
| TOP | 10 | 10 | 10 | 10 |
| Stearic acid | 2 | 2 | 2 | 2 |
| Si69 | 3 | 3 | 3 | 3 |
| 6C | 1 | 1 | 1 | 1 |
| Zinc white | 3 | 3 | 3 | 3 |
| CBS | 0.8 | 0.8 | 0.8 | 0.8 |
| TOT | 0.3 | 0.3 | 0.3 | 0.3 |
| Sulfur | 1.2 | 1.2 | 1.2 | 1.2 |
| Vulcanizaion Speed index | 100 | 115 | 102 | 100 |
| Abrasion test | 100 | 92 | 101 | 102 |
| Laboratory μ index (15° C.) | 100 | 106 | 106 | 106 |

As apparent from the results shown in Table 3 described above, in Example 13, which falls in the scope of the present invention, a natural rubber-filler mixture (carbon black-containing NR master batch) in which carbon black (CB) was mixed in a half amount of the natural rubber was used, and it has been found that the dispersibility is improved and the abrasion resistance is raised although the Vulcanization time is shortened. Further, used in Example 14 was an NR master batch containing a natural rubber and carbon black (1:1), and it has been found that the modulus at a high strain can be raised by diluting with NR to further improve the abrasion resistance. It has been found that a similar effect can be obtained as well in Example 15 in which a viscosity stabilizer (propionohydrazide) was added to the master batch used in Example 14.

Further, as apparent from the results shown in Table 4 described above, vulcanization speed in a silica-NR master batch in Example 16, which falls in the scope of the present invention, is close to that in the Comparative Example 4, which is a control, and it has been found that obtained in Example 16 is a rubber composition which is improved in abrasion resistance and whose performance balance among productivity, abrasion resistance and a Wet performance is good.

In contrast with this, in Comparative Example 5, in which a part of carbon black is substituted with silica, the vulcanization speed is lower, and the vulcanization speed index is large. In this formulation, the vulcanizing time is longer and the vulcanization productivity is deteriorated. Further, it has been found that in a rubber composition in Example 17 in which a viscosity stabilizer (lactohydrazide) was added to the master batch used in Example 16, obtained is a rubber composition which is improved in abrasion resistance to a large extent and has a good balance among abrasion resistance, a Wet performance and productivity.

Evaluation of a Mooney Viscosity of the Respective Rubbers (Raw Materials) After Left Standing for 6 Months.

Measured were Mooney viscosities of the respective rubbers used in the following Examples 18 to 21 and Comparative Examples 6 to 9 immediately after produced, and measured as well were the Mooney viscosities after left standing for 6 months at a temperature of 25° C. and a humidity of 40%. A change in the Mooney viscosities was shown by an index (setting the Mooney viscosity immediately after produced of respective rubber at 100) and evaluated. The results thereof are shown in the following Table 5.

TABLE 5

| Respective rubbers used in examples | Mooney viscosity change index |
|---|---|
| and comparative examples | after left standing for 6 months |
| (1) NR | 140 |
| (2) Aluminum hydroxide-NR master | 106 |
| batch | |
| (3) Aluminum hydroxide-NR master | 138 |
| batch + propionohydrazide | |
| (0.3 phr) | |
| (4) Clay-NR master batch | 104 |
| (5) Clay-NR master batch + | 143 |
| laurohydrazide(0.6 phr) | |

As apparent from the results shown in Table 5 described above, that is, the results of stability of the raw materials to standing, it has been found that the compositions in which a Mooney viscosity has a small change and which are stable with the passage of time are obtained in a system using the viscosity stabilizer, so that a fluctuation and a dispersion in the rubber physical properties are inhibited in a rubber processing step and the workability can be improved.

### Examples 18 to 21 and Comparative Examples 6 to 8

Tire tread rubber compositions for a passenger car tire were prepared according to blending formulations shown in the following Table 6. The blending unit is part by weight.

Conventional RSS #3 was used as the natural rubbers used in Comparative Examples 6 to 8 (an inorganic filler was added in preparing the rubber compositions).

Used in Example 18, 19 and 21 was an aluminum hydroxide-NR master batch obtained by blending an aluminum hydroxide aqueous slurry with a natural rubber latex to obtain a natural rubber-filler mixture liquid and then dried it by using a drum dryer to obtain a master batch of the present invention. The aluminum hydroxide used in Example 21 was smaller in its average particle size than those used in Examples 18 and 19. In Example 19, a propionohydrazide aqueous solution in an amount corresponding to a ratio of 0.3 phr based on the total rubber is further added to the latex at the time of mixing the aqueous slurry used in Example 18 and then treating it in the same manner as in Example 18.

In Example 20, the same aluminum hydroxide as that used in Example 21 was compounded to a DD-NR simultaneously with other compounding ingredients.

The respective rubber compositions thus obtained were evaluated for a laboratory μ index (15° C.) and an abrasion resistance index by the methods described above and shown by indices, wherein the value obtained in Comparative Example 6 was set as a control at 100 and shown by an index. The results thereof are shown in the following Table 6.

TABLE 6

| | Comparative | | | | | | |
|---|---|---|---|---|---|---|---|
| | Example | | | Example | | | |
| | 6 | 7 | 8 | 18 | 19 | 20 | 21 |
| NR | 60 | 60 | 60 | — | — | — | — |
| DD-NR ^{*1} | — | — | — | — | — | 60 | — |
| Aluminum | — | — | — | 90 | 90 | — | — |
| hydroxide ^{*1}-NR | | | | | | | |
| master batch | | | | | | | |
| Aluminum | — | — | — | — | — | — | 90 |
| hydroxide ^{*2}-NR | | | | | | | |
| master batch | | | | | | | |
| SBR | 30 | 30 | 30 | 30 | 30 | 30 | 30 |
| Br-IIR | 10 | 10 | 10 | 10 | 10 | 10 | 10 |
| viscosity | — | — | — | — | 0.3 | — | — |
| stabilizer ^{*4} | | | | | | | |
| Silica ^{*3} | 60 | 60 | 60 | 60 | 60 | 60 | 60 |
| Aluminum | 20 | 30 | — | — | — | — | — |
| hydroxide ^{*1} | | | | | | | |
| Aluminum | — | — | 30 | — | — | 30 | — |
| hydroxide ^{*2} | | | | | | | |
| Si69 | 4 | 4.5 | 4.5 | 4.5 | 4.5 | 4.5 | 4.5 |
| Aromatic oil | 25 | 25 | 25 | 25 | 25 | 25 | 25 |
| Stearic acid | 2 | 2 | 2 | 2 | 2 | 2 | 2 |
| Zinc white | 3 | 3 | 3 | 3 | 3 | 3 | 3 |
| CZ | 2.1 | 2.1 | 2.1 | 2.1 | 2.1 | 2.1 | 2.1 |
| TOT | 1 | 1 | 1 | 1 | 1 | 1 | 1 |
| Sulfur | 1 | 1 | 1 | 1 | 1 | 1 | 1 |
| Laboratory μ | 100 | 108 | 109 | 108 | 108 | 109 | 110 |
| index (15° C.) | | | | | | | |
| Abrasion | 100 | 93 | 93 | 102 | 101 | 100 | 106 |
| resistance | | | | | | | |
| index | | | | | | | |

As apparent from the results shown in Table 6 described above, it has been found that in Comparative Example 7, in which the amount of aluminum hydroxide was simply increased more than in Comparative Example 6, the Wet performance is improved but the abrasion resistance is inferior. On the contrary, in Example 18, in which an aluminum hydroxide master batch was used and the final composition contains the same parts of aluminum hydroxide as that in Comparative Example 7, it has been found that the dispersibility of aluminum hydroxide is improved due to the use of the master batch, and therefore the abrasion resistance index is apparently better than that in Comparative Example 7 and that the wet performance is equivalent to or higher than that in Comparative Example 7 and the abrasion resistance can be compatible with the wet performance. It has been found that a similar effect can be obtained as well in Example 19, in which a viscosity stabilizer (propionohydrazide) was added to the master batch used in Example 18, And in Comparative Example 8, in which an aluminum hydroxide having a smaller particle diameter was used instead of Hygilite H-43M, the Wet performance was somewhat better than Comparative Example 7, but no improvement can be seen in the abrasion resistance. On the contrary, in Example 20, in which a DD-NR was used instead of conventional RSS #3, no deterioration in the abrasion resistance in comparison with Comparative Example 8 was observed and in the Example 21, in which an aluminum hydroxide having a smaller average particle size was used instead of the Hygilite H-43M, further improvement in both the Wet performance and the abrasion resistance can be observed in comparison with the Example 20.

In Example 21, the aluminum hydroxide used in Example 20 was blended with a natural rubber latex to obtain a natural rubber-filler master batch of the present invention, and used. It can be seen that by blending the filler with natural rubber latex, as can be seen from the results, both of laboratory μ index and abrasion resistance are improved.

### Examples 22 to 23 and Comparative Examples 9 to 10

Rubber compositions for inner liners were prepared according to blending formulations shown in the following Table 7. The blending unit is part by weight.

Conventional RSS #3 was used as the natural rubbers used in Comparative Examples 9 and 10 (an inorganic filler was added in preparing the rubber compositions).

A clay-NR master batch was used in Example 22, and a latex having a total rubber component (=DRC) of 30% which was treated with 0.6% of ammonia was mixed with a 30% clay aqueous dispersion (aqueous slurry) in a ratio of 1:1. The mixture was stirred for one minute by means of a stirrer and then treated by means of a drum dryer having a surface temperature of 130° C. to obtain the clay-NR master batch.

Used in Example 23 was a natural rubber obtained by adding laurohydrazide in an amount corresponding to a ratio of 0.6 phr based on the total rubber in a form of an emulsion to a latex at the time of mixing the aqueous dispersion used in Example 22 and then treating it in the same manner as in Example 22.

The respective rubber compositions thus obtained were evaluated for air permeability resistance and a flex cracking growth by the methods described above and shown by indices, wherein the value obtained in Comparative Example 9 was set as a control at 100 and shown by an index. The results thereof are shown in the following Table 7.

TABLE 7

| | |
|---|---|
| Comparative | |
| Example | Example |

| | 9 | 10 | 22 | 23 |
|---|---|---|---|---|
| NR | 70 | 70 | — | — |
| Br-IIR | 30 | 30 | 30 | 30 |
| Clay-NR master batch | — | — | 140 | 140 |
| Viscosity stabilizer*⁶ | — | — | — | 0.6 |
| GPF | 50 | 50 | 50 | 50 |
| Clay | 50 | 70 | — | — |
| Spindle oil | 40 | 48 | 48 | 48 |
| Stearic acid | 2 | 2 | 2 | 2 |
| Zinc white | 2 | 2 | 2 | 2 |
| CZ | 0.8 | 0.8 | 0.8 | 0.8 |
| Sulfur | 1.2 | 1.2 | 1.2 | 1.2 |
| Air permeation resistance | 100 | 115 | 118 | 118 |
| Flex cracking growth | 100 | 122 | 107 | 106 |

As apparent from the results shown in Table 7 described above, it has been found that in Comparative Example 10, in which the amount of clay was simply increased more than in Comparative Example 9, the air permeability resistance is improved but the flex cracking growth is fast.

The clay-NR master batch used in Example 22 contains the same parts of clay as that in Comparative Example 10 in the final composition, but it has been found that dispersibility of clay is improved due to the use of the master batch, and therefore the flex cracking growth is apparently slower than in Comparative Example 10 and that the air permeability resistance is equivalent to or higher than that in Comparative Example 10 and the air permeability resistance can be compatible with the flex cracking growth.

In Example 23, laurohydrazide was added as a viscosity stabilizer to the clay-NR master batch used in Example 22, and it has been found that even the master batch containing the viscosity stabilizer can provide the same effect as that in Example 22 in terms of a performance.

### Examples 24 to 28 and Comparative Examples 11 to 12

Tread rubber compositions of tires for trucks were prepared according to blending formulations shown in the following Table 8. The blending unit is part by weight.

Conventional RSS #4 was used as the natural rubbers used in Comparative Examples 11 and 12.

Used as the natural rubbers (DD-NR^{*4}) used in Examples 24 to 28 was a natural rubber obtained by controlling a fresh latex gathered from a natural rubber tree with water to a total rubber component of 30% and drying it by a drum dryer having a surface temperature of 130° C. for 15 seconds.

The respective natural rubbers thus obtained were used to prepare rubber compositions according to blending formulations shown in the following Table 8, and the resulting rubber compositions were evaluated for a vulcanization speed (T0.9), a tensile strength-holding rate index {(after aging)/(before aging)} after heat aging and a blending cost index by the methods described above. The results thereof are shown in the following Table 8.

TABLE 8

| | Comparative | | | | | | |
|---|---|---|---|---|---|---|---|
| | Example | | Example | | | | |
| | 11 | 12 | 24 | 25 | 26 | 27 | 28 |
| NR | 100 | 100 | — | — | 80 | 94 | — |
| DD-NR ^{*4} | — | — | 100 | 100 | 20 | 6 | 100 |
| Viscosity | — | — | — | — | — | — | 0.3 |
| stabilizer ^{*4} | | | | | | | |
| SAF | 50 | 50 | 50 | 50 | 50 | 50 | 50 |
| Aromatic oil | 3 | 3 | 3 | 3 | 3 | 3 | 3 |
| Resin | 1 | 1 | 1 | 1 | 1 | 1 | 1 |
| Stearic acid | 2 | 2 | 2 | 2 | 2 | 2 | 2 |
| 6C | 1 | 1 | 1 | 1 | 1 | 1 | 1 |
| Zinc white | 3 | 3 | 3 | 3 | 3 | 3 | 3 |
| DZ | 0.8 | 1.8 | 0.8 | 0.3 | 0.6 | 0.8 | 0.3 |
| Sulfur | 1 | 1 | 1 | 1 | 1 | 1 | 1 |
| Vulcanization | 100 | 78 | 58 | 84 | 94 | 100 | 84 |
| speed; T0.9 | | | | | | | |
| Tensile strength- | 82 | 76 | 95 | 96 | 85 | 84 | 96 |
| holding rate | | | | | | | |
| index after heat | | | | | | | |
| aging (after aging/ | | | | | | | |
| before aging) | | | | | | | |
| Blending cost | 100 | 106 | 100 | 97 | 99 | 100 | 97 |
| index | | | | | | | |

As apparent from the results shown in Table 8 described above, it has been found that provided in Examples 24 to 27, which fall in the scope of the present invention are rubber compositions in which a vulcanizing time can readily be shortened and a change in the physical properties after heat aging is not caused, and which is excellent in profitability and productivity as compared with Comparative Examples 11 and 12, which fall outside the scope of the present invention.

Individually observing, it can be found that vulcanization is accelerated in Example 24, in which DD-NR (100% by weight) was used as the rubber component and that as far as the physical properties after aging are concerned, though vulcanization is faster than in Comparative Example 12, in which the vulcanization-accelerator (DZ) was simply increased, the tensile strength-holding rate after heat aging is improved and further better than in Comparative Example 11.

Example 25, in which DD-NR (100% by weight) was used as the rubber component is an example in which the amount of the vulcanization accelerator was decreased, and it can be found that though it is considerably decreased, the vulcanization speed is faster than in Comparative Example 11 and that both of the tensile strength-holding rate and the blending cost are well balanced.

Further, Example 26, in which DD-NR is contained (20% by weight) as the rubber component is an example in which the vulcanization-accelerator was increased (0.6 part) more than in Example 25, but the amount thereof is smaller than in Comparative Example 11. It can be found, however, that the vulcanization speed is faster than in Comparative Example 11 and that both of the tensile strength-holding rate and the blending cost are well balanced.

An amount of DD-NR as the rubber component is small (6% by weight) in Example 27, but it can be found that the tensile strength-holding rate is improved.

In Example 28, DD-NR (100% by weight) was used as the rubber component, and the DD-NR was mixed with 0.3% by weight of propionohydrazide as the viscosity stabilizer. The blending formulation other than addition of the viscosity stabilizer is the same as in Example 25. In addition, it has been found that the results of evaluation of the composition are also the same as in Example 25 and that as shown below, the Mooney viscosity change rate of the raw material rubber in Example 28 is lower than in Example 25, and Mooney viscosity stability of the raw material rubber in Example 28 is better than that of DD-NR in Example 25.

While the raw material rubber had a Mooney viscosity change rate of 45% in the case of DD-NR in Example 25, it was 7% in the case of DD-NR+the viscosity stabilizer in Example 28.

### INDUSTRIAL APPLICABILITY

According to the present invention, obtained is a natural rubber having a higher molecular weight and a smaller polymer gel amount as compared with those of natural rubbers of conventional RSS and TSR, and further obtained is a filler-containing natural rubber both of which can provide a rubber composition excellent in durability such as abrasion resistance, fracture resistance and cracking growth resistance. They can suitably be used for tire members such as treads, bead fillers, belt coating rubbers, carcass ply coating rubbers and side wall rubbers and in addition thereto, other rubber articles, such as hoses, belts and rubber vibration isolators.

1. A natural rubber obtained by drying a natural rubber latex by means of a drum dryer and/or a conveyor type dryer.

2. A natural rubber obtained by drying a natural rubber latex by means of a drum dryer and/or a conveyor type dryer without coagulation.

3. The natural rubber as described in claim 1 or 2, wherein the natural rubber latex described above is at least one of a fresh latex after tapping, a latex blended with a stabilizer and a centrifuged latex.

4. The natural rubber as described in any of claims 1 to 3, wherein the natural rubber latex described above has a solid concentration of 5% by weight or more.

5. The natural rubber as described in claim 4 containing a viscosity stabilizer.

6. The natural rubber as described in claim 5, wherein the viscosity stabilizer is a hydrazide compound represented by the following Formula (I):
R—CONHNH₂ (I)
wherein R represents an alkyl group having 1 to 30 carbon atoms, a cycloalkyl group having 3 to 30 carbon atoms or an aryl group.

7. The natural rubber as described in claim 5, wherein the viscosity stabilizer comprises at least one ester compound selected from the group consisting of aromatic polycarboxylic acid derivatives represented by the following Formula (II) and aliphatic polycarboxylic acid derivatives represented by the following Formula (III): 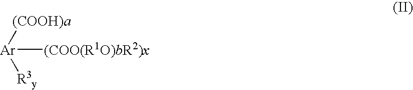
wherein b is an average degree of polymerization, and represents an integer of 1 or more; a and x each represent an integer of 1 or more; y represents an integer of 0 or more, and a relation of a+x+y=6 is satisfied; Ar is an aromatic hydrocarbon group; R¹ represents an alkylene group; R² represents any of an alkyl group, an alkenyl group, an alkylaryl group and an acyl group; R³ represents any of a hydrogen atom, an alkyl group and an alkenyl group. 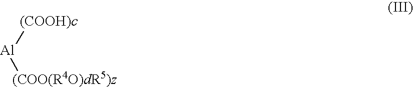
wherein d is an average degree of polymerization, and represents an integer of 1 or more; c and z each represent an integer of 1 or more; Al is a saturated or unsaturated aliphatic hydrocarbon group; R⁴ represents an alkylene group; R⁵ represents any of an alkyl group, an alkenyl group, an alkylaryl group and an acyl group.

8. The natural rubber as described in claim 5, wherein the viscosity stabilizer is an ester of a polycarboxylic acid with a (poly)oxyalkylene derivative, with at least one free carboxyl group bonded to the aromatic or aliphatic hydrocarbon group.

9. The natural rubber as described in claim 6, wherein the hydrazide compound is at least one selected from the group consisting of acetohydrazide, propionohydrazide, butyrohydrazide, laurohydrazide, palmitohydrazide, stearohydrazide, cyclopropanecarbohydrazide, cyclohexanecarbohydrazide, cyclobutanecarbohydrazide, cycloheptanecarbohydrazide, o-toluohydrazide, m-toluohydrazide, p-toluohydrazide, benzohydrazide, lactohydrazide, phthalohydrazide, p-methoxybenzohydrazide, 3,5-dimethylbenzohydrazide and 1-naphthohydrazide.

10. A natural rubber-filler mixture comprising a natural rubber as described in any of claims 1 to 9 and a filler.

11. A natural rubber-filler mixture as described in claim 10, wherein the filler is at least one selected from the group consisting of carbon black, silica, aluminas represented by the following Formula (IV), calcium carbonate, talc, kaolin, clay, mica, and feldspar.
Al₂O₃ mH₂O (IV)
wherein m is an integer of 0 to 3.

12. The natural rubber-filler mixture as described in claim 10 or 11, wherein the filler described above has a content of 5 to 200% by weight based on a dry weight of the rubber component contained in the natural rubber latex.

13. A rubber composition obtained by compounding a rubber component as described in any of claims 1 to 9, and a filler.

14. A rubber composition obtained by compounding a rubber-filler mixture as described in any of claims 10 to 12.

15. A production process for a natural rubber characterized by drying a natural rubber latex by means of a drum dryer and/or a conveyor type dryer.

16. The production process for a natural rubber as described in claim 15, wherein a natural rubber latex is dried in the form of a sheet by means of the drum dryer, and the sheet-shaped natural rubber latex is further dried by means of the conveyor type dryer.

17. The production process for a natural rubber as described in claim 15 or 16, further comprising a step of adding a viscosity stabilizer.

18. A production process for a natural rubber-filler mixture comprising:
a step of adding at least one filler selected from the group consisting of carbon black, silica, aluminas represented by the following Formula (IV), calcium carbonate, talc, kaolin, clay, mica, and feldspar to a natural rubber latex; and
a step of drying the natural rubber latex-filler mixture.
Al₂O₃ mH₂O (IV)
wherein m is an integer of 0 to 3.

19. The production process for a natural rubber-filler mixture as described in claim 18, further comprising a step of adding a viscosity stabilizer.

20. The production process for a natural rubber-filler mixture as described in claim 18, wherein drying is carried out by means of a drum dryer and/or a conveyor type dryer.
